(19) United States
(12) Patent Application Publication
(10) Pub. No.: US 2024/0310243 A1
(43) Pub. Date: Sep. 19, 2024

(54) INTERFEROGRAM PHASE ESTIMATION METHOD

(71) Applicant: BEIJING INSTITUTE OF TECHNOLOGY, Beijing (CN)

(72) Inventors: Mingfeng LU, Beijing (CN); Tianshan ZHANG, Beijing (CN); Peihang LI, Beijing (CN); Chenchen JI, Beijing (CN); Jinmin WU, Beijing (CN); Yao HU, Beijing (CN); Weidong HU, Beijing (CN); Feng ZHANG, Beijing (CN); Ran TAO, Beijing (CN)

(73) Assignee: BEIJING INSTITUTE OF TECHNOLOGY, Beijing (CN)

(21) Appl. No.: 18/398,607

(22) Filed: Dec. 28, 2023

(30) Foreign Application Priority Data
Dec. 28, 2022 (CN) 202211694760.8

(51) Int. Cl. G01M 11/00; G06T 7/60

(52) U.S. Cl. CPC G01M 11/30; G06T 7/60; G06T 2207/20081; G06T 2207/20084; G06T 2207/20132

(57) ABSTRACT

The present application relates to an interferogram phase estimation method. The interferogram phase estimation method includes: obtaining an interferogram for estimation of a measured object; and inputting the interferogram for estimation to a neural network model trained based on a method for training a neural network model for interferogram phase estimation, to obtain a phase image corresponding to the interferogram for estimation. In the interferogram phase estimation method of the present application, features of different scales of an interferogram are learned based on a Unet++ neural network model to obtain an accurately estimated phase image corresponding to the interferogram.

### FIELD OF THE INVENTION

The present application relates to the field of optical measurement technologies, and more specifically, to a method for training a neural network model for interferogram phase estimation and a neural network model-based interferogram phase estimation method.

### BACKGROUND OF THE INVENTION

Interferometry is a very important technology in the field of optical measurement, and is widely applied due to high sensitivity and accuracy in measurement. In this technology, coherent light generates interference to a measured element to form an interferogram. Analyzing the interferogram is a core of interferometry. Interferogram analysis mainly needs to extract an interferogram phase including information about a measured object.

Conventional phase extraction methods mainly fall into two categories: phase shifting methods and spatial demodulation methods, both of which have advantages and disadvantages.

The phase shifting method includes two different kinds of temporal phase shifting method and spatial phase shifting method. The temporal phase shifting method requires piezoelectric ceramics to perform phase shifting to generate a plurality of images. The temporal phase shifting method is time spending, and is also sensitive to vibration and interference of an instrument. In the spatial phase shifting method, fringes of different phases are generated by a polarization apparatus, and are displayed in a single frame of image. No extra time is required, and robustness to external interference is higher. However, the accuracy is lower due to a resolution constraint of a CCD camera. Moreover, both the temporal and spatial phase shifting methods are required to be completed by specialized devices, which brings hardware costs.

Phase-shifting-free single-interferogram analysis is always a focus of current research. As a mainstream, the spatial demodulation method uses Fourier transform analysis, and is also referred to as a Fourier transform method. In the spatial demodulation method, a phase may be obtained from a single-frame interferogram. The spatial demodulation method is usually susceptible to noise and uneven illumination. In addition, the spatial demodulation method is not suitable for analyzing closed fringes that are quite common in industry, for example, Newton's rings. Analyzing the Newton's rings may estimate physical parameters, for example, a radius of curvature and a location of a spherical element, and a vertex offset and an optical fiber height of an end face of an optical fiber connector. Even though a carrier may be introduced to convert the closed fringes into open ones, such carrier modulation is implemented through inclination or defocusing, which may introduce an extra error, leading to degradation of accuracy.

In addition, a phase obtained by either the phase shifting method or the spatial demodulation method is wrapped, and requires an unwrapping algorithm. The unwrapping algorithm is susceptible to noise and interference, leading to degradation of accuracy.

Therefore, it is necessary to develop a more concise interference fringe analysis method that does not need phase shifting, modulation, unwrapping, or the like.

Deep learning is a massive data learning-based rule analysis method. Due to a high data fitting capability, deep learning has outstanding performance in many application fields.

Based on this, the present application is intended to provide a deep-learning-based interferogram based phase estimation solution.

### SUMMARY OF THE INVENTION

Embodiments of the present application provide a method for training a neural network model for interferogram phase estimation and a neural network model-based interferogram phase estimation method. Features of different scales of an interferogram are learned based on a Unet++ neural network model to obtain an accurately estimated phase image corresponding to the interferogram.

According to an aspect of the present application, a method for training a neural network model for interferogram phase estimation is provided, which includes: obtaining a training interferogram and a true phase image of the training interferogram; inputting the training interferogram to a neural network model, wherein the neural network model has N convolutional layer branches, an i^{th} convolutional layer branch in the N convolutional layer branches has N+1−i convolutional layer branches that are cascaded, 1≤i≤N, and an output feature map of a first convolutional layer in the i^{th} convolutional layer branch is down-sampled and then input to a first convolutional layer in an (i+1)^{th} convolutional layer branch, and an output feature map of a j^{th} convolutional layer in the (i+1)^{th} convolutional layer branch is up-sampled and then input to a (j+1)^{th} convolutional layer in the i^{th} convolutional layer branch, 1≤j≤N+1−i, and an output feature map of each convolutional layer in the i^{th} convolutional layer branch is input to each downstream convolutional layer of the convolutional layer; obtaining a predicted phase image output by the neural network model; calculating a loss function value between the predicted phase image and the true phase image; and training, by minimizing the loss function value, the neural network model through gradient back propagation.

In the method for training a neural network model for interferogram phase estimation, obtaining a training interferogram includes: imaging a predetermined object through a predetermined image acquisition device to obtain the training interferogram.

In the method for training a neural network model for interferogram phase estimation, imaging a predetermined object through a predetermined image acquisition device to obtain the training interferogram includes: imaging the predetermined object through the predetermined image acquisition device based on a multi-step phase shifting method to obtain a plurality of interferograms with a plurality of phases; and obtaining a phase-shift-free interferogram as the training interferogram.

In the method for training a neural network model for interferogram phase estimation, a quantity of convolutional layer branches of the neural network model is 4, and a quantity of convolution kernels is doubled from 32, and a size of a convolution kernel is 5×5.

In the method for training a neural network model for interferogram phase estimation, each convolution layer includes a ResBlock convolution block.

In the method for training a neural network model for interferogram phase estimation, before inputting the training interferogram to a neural network model, the method further includes: performing image cropping or image augmentation on the training interferogram.

In the method for training a neural network model for interferogram phase estimation, performing image cropping or image augmentation on the training interferogram includes: when a quantity of convolution layer branches is less than or equal to a predetermined threshold, performing image cropping on the training interferogram; or when a quantity of convolution layer branches is greater than a predetermined threshold, performing image augmentation on the training interferogram.

In the method for training a neural network model for interferogram phase estimation, the performing image cropping or image augmentation on the training interferogram includes: when image cropping is performed on the training interferogram, a quantity of pixels in a cropped image is sufficient to fit an ideal sphere.

In the method for training a neural network model for interferogram phase estimation, the loss function value is a root mean square error loss function value, and is represented as:

$${ℒ}_{RMSE} = \sqrt{\frac{1}{k} {\sum }_{i = 1}^{k} {( {F}_{1}^{( i )} - {F}_{2}^{( i )} )}^{2}}$$

wherein F₁⁽ⁱ⁾ and F₂⁽ⁱ⁾ are respectively matrix representations of a predicted phase image and a true phase image that correspond to an i^{th} interferogram in k interferograms in total, and matrix sizes of the predicted phase image and the true phase image are m×n.

In the method for training a neural network model for interferogram phase estimation, the loss function value is a relative root mean square error loss function value, and is represented as:

$${ℒ}_{RRMSE} = \frac{1}{k} {\sum }_{i = 1}^{k} \frac{\sqrt{{\sum }_{a = 1}^{m} {\sum }_{b = 1}^{n} {( {F}_{{1}_{a , b}}^{( i )} - {F}_{{2}_{a , b}}^{( i )} )}^{2}}}{{max}_{a , b} ( {F}_{{2}_{a , b}}^{( i )} ) - {min}_{a , b} ( {F}_{{2}_{a , b}}^{( i )} )}$$

wherein F₁⁽ⁱ⁾_{a,b} and F₂⁽ⁱ⁾_{a,b} are respectively pixel values at a location (a, b) in a predicted phase image and a true phase image that correspond to an i^{th} interferogram in k interferograms in total.

According to another aspect of the present application, an interferogram phase estimation method is provided, including: obtaining an interferogram for estimation of a measured object; and inputting the interferogram for estimation to a neural network model trained based on a method for training a neural network model for interferogram phase estimation, to obtain a phase image corresponding to the interferogram for estimation; wherein the method for training a neural network model for interferogram phase estimation including: obtaining a training interferogram and a true phase image of the training interferogram; inputting the training interferogram to a neural network model, wherein the neural network model has N convolutional layer branches, an i^{th} convolutional layer branch in the N convolutional layer branches has a plurality of N+1−i convolutional layer branches that are cascaded, 1≤i≤N, an output feature map of a first convolutional layer in the i^{th} convolutional layer branch is down-sampled and then input to a first convolutional layer in an (i+1)^{th} convolutional layer branch, an output feature map of a j^{th} convolutional layer in the (i+1)^{th} convolutional layer branch is up-sampled and then input to a (j+1)^{th} convolutional layer in the i^{th} convolutional layer branch, 1≤j≤N+1−i, and an output feature map of each convolutional layer in the i^{th} convolutional layer branch is input to each downstream convolutional layer of the convolutional layer; obtaining a predicted phase image output by the neural network model; calculating a loss function value between the predicted phase image and the true phase image; and training, by minimizing the loss function value, the neural network model through gradient back propagation.

In the interferogram phase estimation method, the measured object is an interferogram of the optical fiber end face.

In the interferogram phase estimation method, obtaining an interferogram for estimation of a measured object includes imaging the optical fiber end face through a predetermined image acquisition device to obtain the interferogram of the optical fiber end face.

In the interferogram phase estimation method, obtaining an interferogram for estimation of a measured object includes: providing an optical fiber connector to be determined qualified; and imaging the optical fiber end face of the optical fiber connector through a predetermined image acquisition device to obtain the interferogram of the optical fiber end face

In the interferogram phase estimation method, obtaining a training interferogram includes: imaging a predetermined object through a predetermined image acquisition device to obtain the training interferogram.

In the interferogram phase estimation method, imaging a predetermined object through a predetermined image acquisition device to obtain the training interferogram includes: imaging the predetermined object through the predetermined image acquisition device based on a multi-step phase shifting method, to obtain a plurality of interferograms with a plurality of phases; and obtaining a phase-shift-free interferogram as the training interferogram.

In the interferogram phase estimation method, a quantity of convolutional layer branches of the neural network model is 4, a quantity of convolution kernels is doubled from 32, and a size of a convolution kernel is 5×5.

In the interferogram phase estimation method, each convolution layer comprises a ResBlock convolution block.

In the interferogram phase estimation method, before the inputting the training interferogram to a neural network model, the method further comprises: performing image cropping or image augmentation on the training interferogram.

In the interferogram phase estimation method, the performing image cropping or image augmentation on the training interferogram comprises: when a quantity of convolution layer branches is less than or equal to a predetermined threshold, performing image cropping on the training interferogram; or when a quantity of convolution layer branches is greater than a predetermined threshold, performing image augmentation on the training interferogram.

In the interferogram phase estimation method, the performing image cropping or image augmentation on the training interferogram comprises: when image cropping is performed on the training interferogram, a quantity of pixels in a cropped image is sufficient to fit an ideal sphere.

In the interferogram phase estimation method, the loss function value is a root mean square error loss function value, and is represented as:

$${ℒ}_{RMSE} = \sqrt{\frac{1}{k} {\sum }_{i = 1}^{k} {( {F}_{1}^{( i )} - {F}_{2}^{( i )} )}^{2}}$$

wherein F₁⁽ⁱ⁾ and F₂⁽ⁱ⁾ are respectively matrix representations of a predicted phase image and a true phase image that correspond to an ith interferogram in k interferograms in total, and matrix sizes of the predicted phase image and the true phase image are m×n.

In the interferogram phase estimation method, the loss function value is a relative root mean square error loss function value, and is represented as:

$${ℒ}_{RRMSE} = \frac{1}{k} {\sum }_{i = 1}^{k} \frac{\sqrt{{\sum }_{a = 1}^{m} {\sum }_{b = 1}^{n} {( {F}_{{1}_{a , b}}^{( i )} - {F}_{{2}_{a , b}}^{( i )} )}^{2}}}{{max}_{a , b} ( {F}_{{2}_{a , b}}^{( i )} ) - {min}_{a , b} ( {F}_{{2}_{a , b}}^{( i )} )}$$

wherein F₁⁽ⁱ⁾_{a,b} and F₂⁽ⁱ⁾_{a,b} are respectively pixel values at a location (a, b) in a predicted phase image and a true phase image that correspond to an ith interferogram in k interferograms in total.

According to the method for training a neural network model for interferogram phase estimation and the neural network model-based interferogram phase estimation method, importance of features of different depths can be learned based on a Unet++ neural network model to obtain an accurate phase image corresponding to an interferogram.

### BRIEF DESCRIPTION OF DRAWINGS

Other advantages and benefits of the present application become apparent to a person of ordinary skill in the art by reading detailed description of the following preferred specific implementations. The accompanying drawings are merely intended to illustrate the preferred implementations and are regarded as a limitation on the present application. Clearly, the accompanying drawings in the following description merely show some embodiments of the present application, and a person of ordinary skill in the art can derive other accompanying drawings from these accompanying drawings without creative efforts. Throughout the accompanying drawings, the same reference numerals represent the same components.

FIG. 1 shows an interferogram of an optical fiber end face.

FIG. 2 shows a schematic overall process of a phase estimation method for an optical fiber end face according to an embodiment of the present application.

FIG. 3 shows a schematic U-net structure for phase estimation of an optical fiber end face.

FIG. 4 is a flowchart of a method for training a neural network model for interferogram phase estimation according to an embodiment of the present application.

FIG. 5 is a schematic diagram of a training interferogram and a true phase image of the training interferogram according to an embodiment of the present application.

FIG. 6 shows a schematic U-net++ structure.

FIG. 7 is a schematic diagram of a ResBlock convolution block used in a neural network model according to an embodiment of the present application.

FIG. 8 is a flowchart of an interferogram phase estimation method according to an embodiment of the present application.

FIG. 9 is a schematic diagram of a predicted phase result of a preferred neural network model architecture.

FIG. 10 shows a more general example of simulated interferogram phase estimation.

FIG. 11 shows a more general example of actual interferogram phase estimation.

FIG. 12 is a schematic diagram of an error caused by noise in an interferogram phase estimation method according to an embodiment of the present application.

### DESCRIPTION OF EMBODIMENTS

Exemplary embodiments according to the present application will now be described in detail with reference to the drawings. Clearly, the described embodiments are merely some but not all of the embodiments of the present application. It should be understood that the present application is not limited to the exemplary embodiments described herein.

### SUMMARY OF THE APPLICATION

An optical fiber connector is a device that connects a light source to an optical fiber, connects optical fibers, and connects an optical fiber to a detector in optical fiber communication, and it is one of most used passive devices in optical communication. A main body of the optical fiber connector includes an optical fiber ceramic ferrule, and a micropore in the center is configured to fix an optical fiber.

Quality and a geometrical shape of an end face of the optical fiber connector directly affect optical signal transmission efficiency. A grinding defect of an end face of a connector that connects two optical fibers may increase an insertion loss and a return loss of the connector, and consequently, optical signal performance of an optical link is reduced, or even an optical signal cannot be transmitted.

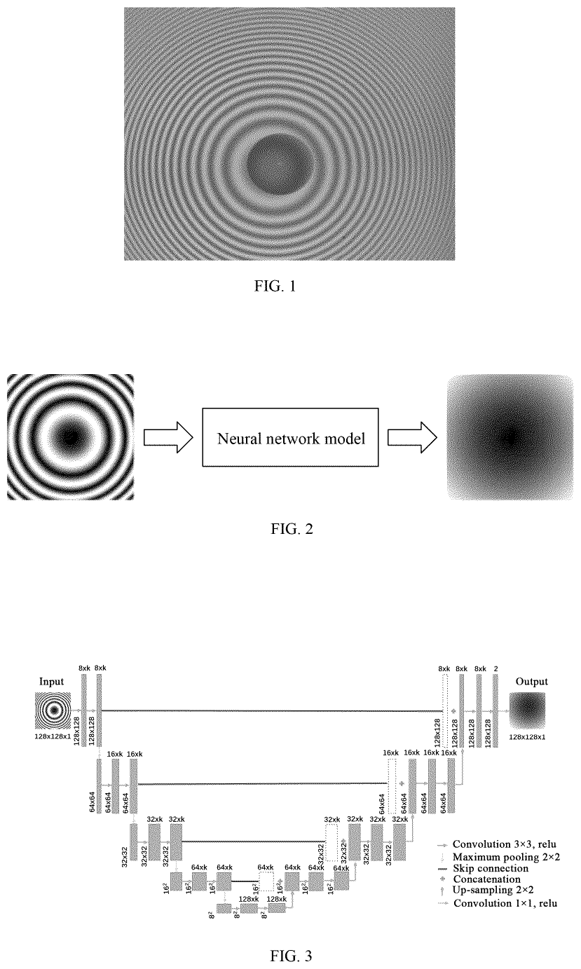

To better determine whether a produced optical fiber connector is qualified, the International Electrotechnical Commission (IEC) has a series of requirements on three-dimensional shape parameters of an end face of the optical fiber connector. For all produced optical fiber connectors, detection and provision of details about a grinding status of an end face are required. The details are required to include three-dimensional imaging and two-dimensional contour display of an optical fiber end face as well as key parameters such as a radius of curvature, a vertex offset, an optical fiber height (optical fiber recess/protrusion degree), and an end face inclination angle. Whether the connector can be qualified for use based on these indexes. The optical fiber end face is also measured through interferometry. Interferometric imaging is performed on the optical fiber connector to obtain an interferogram as shown in FIG. 1. FIG. 1 shows the interferogram of the optical fiber end face. As shown in FIG. 1, the entire interferogram includes Newton's rings and a dark spot. The Newton's rings are formed by performing interferometric imaging on the entire end face that is a microsphere. The dark spot is located at a fiber core. Materials of the fiber core and the ferrule have different refractive indexes, so the dark spot may affect a part of the interferogram.

In addition to the Newton's rings, the interferogram of the optical fiber end face further includes the dark spot that is caused by the fiber core and that occludes fringes. In addition, the fiber core and the ferrule are made from different materials with different refractive indexes, so a shade at which the fiber core is located not only occludes the fringes but also deforms some fringes. Moreover, the optical fiber height parameter is more accurate than the other parameters, usually measured in units of nanometers (nm), so that phase analysis is usually required to ensure estimation accuracy. In addition, surface roughness is also required to be obtained through a shape distribution obtained through phase retrieval. Therefore, in a method for detecting the end face of the optical fiber connector, a phase is usually extracted from the interferogram of the optical fiber end face to obtain the shape distribution of the end face, and then parameter estimation may be performed.

In the interferogram of the optical fiber end face, the phase of the interferogram and a size of the interferogram are consistent, and there is a point-to-point mapping relationship. Existing interferogram phase analysis methods are mainly multi-interferogram-based phase shifting methods and single-interferogram-based Fourier transform methods. These methods have some shortcomings in phase estimation of a closed interferogram. Therefore, in the present application, a deep learning convolutional neural network is used to perform phase estimation on the closed interferogram.

Herein, in the embodiments of the present application, in addition to an interferogram of a sphere such as the optical fiber end face, as described above, in interferometry, interferometric imaging may further be performed on other types of measured objects to form various fringe patterns for measurement of a general surface type. In addition, in the embodiments of the present application, the interferogram is not required to be a closed ring interferogram, and may also be open fringes formed by a part of a ring interferogram, for example, a part of Newton's rings.

Therefore, an interferogram phase estimation method according to the embodiments of the present application may be applied to phase estimation for interferometric imaging of various types of measured objects, not limited to phase estimation of Newton's rings of a sphere such as an optical fiber end face.

Specifically, a phase of a closed fringe pattern is estimated through deep learning, and a used convolutional neural network directly outputs a phase image corresponding to the input fringe pattern. A process is shown in FIG. 2. FIG. 2 is a schematic overall flowchart of the interferogram phase estimation method according to an embodiment of the present application. For the input fringe pattern, an output of the neural network is an image of a same size as the input, in point-to-point mapping with the input.

Moreover, in the embodiments of the present application, the output phase image is an unwrapped phase image. That is, the phase image corresponding to the interferogram may be obtained without any postprocessing on the output of the neural network.

For example, the selected neural network may be U-net. Information of each level is enriched through up-sampling, down-sampling, and skip connection, and information lost in a continuous down-sampling process can be compensated. FIG. 3 shows a schematic U-net structure for interferogram phase estimation.

### Schematic Training Method

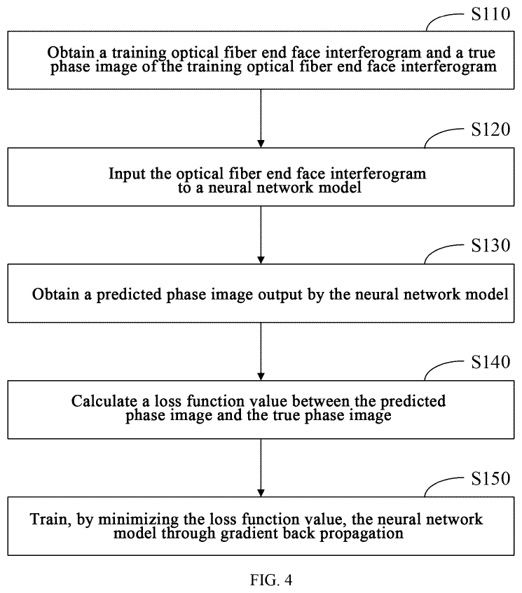

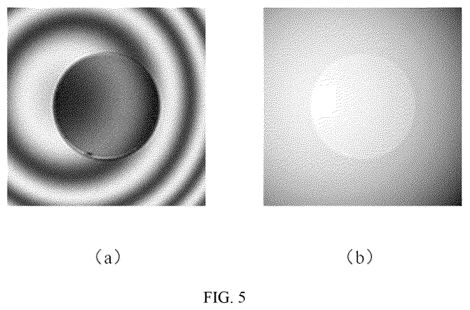

FIG. 4 is a flowchart of a method for training a neural network model for interferogram phase estimation according to an embodiment of the present application.

As shown in FIG. 4, the method for training a neural network model for interferogram phase estimation according to this embodiment of the present application includes the following steps.

Step S110: obtain a training interferogram and a true phase image of the training interferogram. Specifically, FIG. 5 is a schematic diagram of the training interferogram and the true phase image of the training interferogram according to an embodiment of the present application. As shown in FIG. 5, the training interferogram is a true interferogram shown in (a) in FIG. 5, and the true phase image is a phase image that corresponds to the true interferogram and that is shown in (b) in FIG. 5.

Specifically, the true interferogram may be obtained by a dedicated image acquisition device by imaging a predetermined to-be-measured object, for example, an optical fiber end face. For example, an interferogram of the optical fiber end face is obtained by Mars-ML400 manufactured by Hangzhou Qiyue Technology Co., Ltd. through imaging. Specifically, Mars-ML400 performs measurement based on a principle of a five-step phase shifting method to obtain the interferogram of the optical fiber end face (the phase is shifted by π/2 each time, so a last image is theoretically the same as a first image). Therefore, each optical fiber connector end face is measured through Mars-ML400 to obtain five cropped optical fiber end face interferograms of which sizes are 223×223 and that are included in a measured region (a corresponding physical size is 140 μm to 250 μm). In this embodiment of the present application, phase estimation is required to be performed on a single carrier-free optical fiber end face interferogram, so that only a first interferogram and a fifth interferogram obtained without phase shifting in each interferometric imaging may be used.

A person skilled in the art can understand that the optical fiber end face is used as an example above, but for another to-be-measured object, the training interferogram may also be obtained through imaging with the predetermined image acquisition device, and in addition, the multi-step phase shifting method may also be used during imaging with the predetermined image acquisition device.

Then, the true phase image corresponding to the true interferogram is obtained through calculation based on the true interferogram. For example, a multi-interferogram-based phase shifting method and a single-interferogram-based Fourier transform method may be used. Details are not described herein again.

Therefore, in the method for training a neural network model for interferogram phase estimation according to this embodiment of the present application, obtaining the training interferogram includes: imaging a predetermined object through a predetermined image acquisition device to obtain the training interferogram.

In addition, in the method for training a neural network model for interferogram phase estimation according to this embodiment of the present application, imaging the predetermined object through the predetermined image acquisition device to obtain the training interferogram includes: imaging the predetermined object through the predetermined image acquisition device based on a multi-step phase shifting method, to obtain a plurality of interferograms with a plurality of phases; and obtaining a phase-shift-free interferogram as the training interferogram.

Moreover, nonlinear normalization processing may be performed on the true interferogram.

Step S120: input the training interferogram to a neural network model, wherein the neural network model has N convolutional layer branches, and an i^{th} convolutional layer branch in the N convolutional layer branches has N+1−i convolutional layer branches that are cascaded, 1≤i≤N, and an output feature map of a first convolutional layer in the i^{th} convolutional layer branch is down-sampled and then input to a first convolutional layer in an (i+1)^{th} convolutional layer branch, and an output feature map of a j^{th} convolutional layer in the (i+1)^{th} convolutional layer branch is up-sampled and then input to a (j+1)^{th} convolutional layer in the i^{th} convolutional layer branch, 1≤j≤N+1−i, and an output feature map of each convolutional layer in the i^{th} convolutional layer branch is input to each downstream convolutional layer of the convolutional layer.

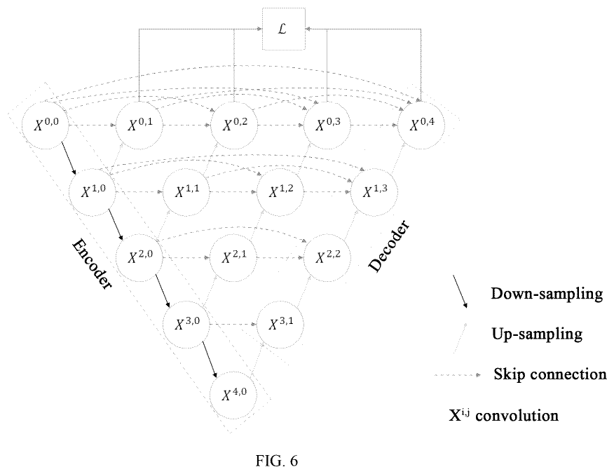

Herein, in this embodiment of the present application, the neural network model is referred to as a U-net++ convolutional neural network. FIG. 6 shows a schematic U-net++ structure. FIG. 6 shows a schematic U-net++ structure with five convolutional layer branches. As shown in FIG. 6, a first convolutional layer branch in the five convolutional layer branches has five cascaded convolutional layers in a same quantity as the convolutional layer branches. In addition, each time a sequence number of the convolutional layer branch increases by 1, a quantity of cascaded convolutional layers included in the convolutional layer branch decreases by 1. That is, a second convolutional layer branch has four cascaded convolutional layers, and by analogy, a fifth convolutional layer branch has one convolutional layer.

An output feature map of a first convolutional layer in each convolutional layer branch is down-sampled and then input to a first convolutional layer in a next convolutional layer branch, as shown by a solid arrow that represents down-sampling and that points to a bottom-right direction in FIG. 6. An output feature map of each convolutional layer in each convolutional layer branch other than the first convolutional layer branch is up-sampled and then input to a next convolutional layer in a previous convolutional layer branch, as shown by a solid arrow that represents up-sampling and that points to a top-right direction in FIG. 6. In addition, inside each convolutional layer branch, an output feature map of an upstream convolutional layer (that is, a convolutional layer on the left in FIG. 6) is input to each downstream convolutional layer (that is, a convolutional layer on the right in FIG. 6) of the upstream convolutional layer. That is, inside each convolutional layer branch, the feature maps are transmitted backward by layers, and are also subjected to skip connection.

Herein, the neural network model according to this embodiment of the present application is still designed based on an encoder-decoder structure. The plurality of convolutional layer branches of the neural network model are for adaptation to different features of various data sets. For different data sets, features of different levels of the neural network have different importance, so that the plurality of convolutional layer branches can enable the neural network to learn importance of features of different depths. In addition, down-sampling and up-sampling feature fusion is performed between the plurality of convolutional layer branches to make features of all depths available, so that the neural network autonomously learns importance of features of different depths. Moreover, the neural network model shares one feature extractor, so that only one encoder rather than a plurality of encoders is required to be trained, and when features of different levels are required, recovery is performed through different decoder paths. Furthermore, in the neural network model according to this embodiment of the present application, the cascaded convolutional layers in each convolutional layer branch have matched long connections and short connections, so that feature fusion between the levels is implemented, and the quantity of parameters of a deep network with a plenty of parameters can be greatly reduced within an acceptable accuracy range.

Specifically, for a convolution kernel of each convolutional layer in the neural network model, a quantity and a size of convolution kernels may be set. For example, the quantity of convolution kernels may be doubled from 16 or from 32, and the size of the convolution kernel may be 3×3 or 5×5.

An experiment shows that when the quantity of convolutional layer branches is 4, the quantity of convolution kernels is doubled from 32, and the size of the convolution kernel is 5×5, the neural network model has best performance. Compared with a neural network model with five convolutional layer branches, the neural network model has fewer parameters and a lower requirement on a hardware resource, requires less test time, is more suitable for actual application, and is also accurate. Specific experimental data and results are described below in detail.

Therefore, in the method for training a neural network model for interferogram phase estimation according to this embodiment of the present application, the quantity of convolutional layer branches of the neural network model is 4, the quantity of convolution kernels is doubled from 32, and the size of the convolution kernel is 5×5.

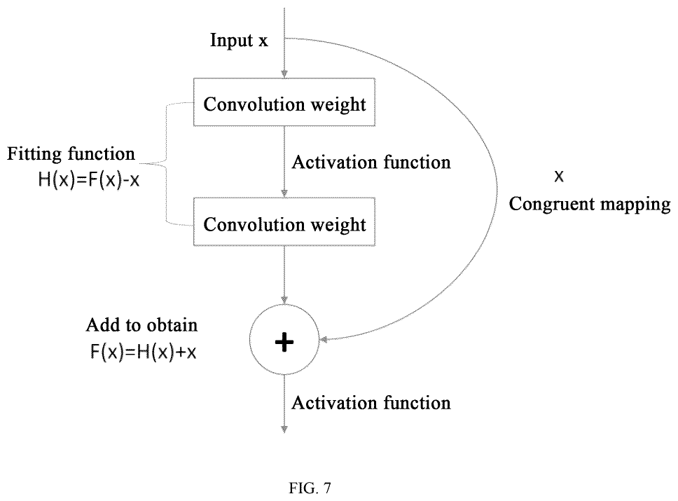

In addition, in this embodiment of the present application, each convolutional layer may include a predetermined convolution block, for example, an ordinary initial convolution block. Herein, each convolutional layer preferably includes a ResBlock convolution block, as shown in FIG. 7. FIG. 7 is a schematic diagram of the ResBlock convolution block used in the neural network model according to an embodiment of the present application. A residual learning framework of the ResBlock convolution block may implement optimization more easily than direct mapping, so that a degradation problem in a case of a large network depth can be solved. In addition, residual connection of the ResBlock convolution block is combined with dense skip connection in the neural network model, so that a gradient flow during network training can be improved, and this design ensures a probability of training a deep network with a plenty of parameters.

In addition, a feature map is required to be down-sampled for many times in the neural network model, so that the training interferogram may be preprocessed, to meet a requirement on a size of a down-sampled feature map.

Specifically, for an image of a size of 223×223 acquired by Mars-ML400, image cropping may be performed, for example, an edge of the image is cropped, to obtain a 208×208 image. That is, the data is sufficient to obtain an ideal sphere through fitting based on a spherical fitting principle.

Alternatively, image augmentation may be performed on the original 223×223 image, for example, one row and one column are padded with zero, to obtain a 224×224 image. In addition, after a phase image is obtained, a shape may be obtained based on the phase image, and then row/column data formed through padding is removed to obtain an estimated phase of an original size.

In addition, in this embodiment of the present application, the training interferogram may be preprocessed based on the quantity of convolutional layer branches. That is, when the quantity of convolution layer branches is less than or equal to a predetermined threshold, image cropping is performed on the training interferogram; or when the quantity of convolution layer branches is greater than a predetermined threshold, image augmentation is performed on the training interferogram.

For example, for an image of a size of 208×208, a U-net++ with four convolutional layer branches is used; and for an image of a size of 224×224, a U-net++ with five convolutional layer branches is used.

Therefore, in the method for training a neural network model for interferogram phase estimation according to this embodiment of the present application, before the training interferogram is input to the neural network model, the method further includes: performing image cropping or image augmentation on the training interferogram.

In addition, in the method for training a neural network model for interferogram phase estimation according to this embodiment of the present application, performing image cropping or image augmentation on the training interferogram includes: when the quantity of convolution layer branches is less than or equal to the predetermined threshold, performing image cropping on the training interferogram; or when the quantity of convolution layer branches is greater than the predetermined threshold, performing image augmentation on the training interferogram.

In addition, in the method for training a neural network model for interferogram phase estimation according to this embodiment of the present application, performing image cropping or image augmentation on the training interferogram includes: when image cropping is performed on the training interferogram, a quantity of pixels in a cropped image is sufficient to fit an ideal sphere.
Step S130: obtain a predicted phase image output by the neural network model. Herein, as shown in FIG. 3, the obtained predicted phase image is also a phase image similar to the true phase image but having an error with the true phase image because of a difference of prediction accuracy of the neural network model.
Step S140: calculate a loss function value between the predicted phase image and the true phase image. Specifically, in this embodiment of the present application, the loss function value may be a root mean square error (RMSE) loss function value, and is represented as:

$${ℒ}_{RMSE} = \sqrt{\frac{1}{k} {\sum }_{i = 1}^{k} {( {F}_{1}^{( i )} - {F}_{2}^{( i )} )}^{2}}$$

wherein F₁⁽ⁱ⁾ and F₂⁽ⁱ⁾ are respectively matrix representations of a predicted phase image and a true phase image that correspond to an i^{th} interferogram in k interferograms in total, and matrix sizes of the predicted phase image and the true phase image are m×n.

In the method for training a neural network model for interferogram phase estimation, the loss function value is a relative root mean square error loss function value, and is represented as:

$${ℒ}_{RRMSE} = \frac{1}{k} {\sum }_{i = 1}^{k} \frac{\sqrt{{\sum }_{a = 1}^{m} {\sum }_{b = 1}^{n} {( {F}_{{1}_{a , b}}^{( i )} - {F}_{{2}_{a , b}}^{( i )} )}^{2}}}{{max}_{a , b} ( {F}_{{2}_{a , b}}^{( i )} ) - {min}_{a , b} ( {F}_{{2}_{a , b}}^{( i )} )}$$

wherein F₁⁽ⁱ⁾_{a,b} and F₂⁽ⁱ⁾_{a,b} are respectively pixel values at a location (a, b) in a predicted phase image and a true phase image that correspond to an i^{th} interferogram in k interferograms in total.
Step S150: Train, by minimizing the loss function value, the neural network model through gradient back propagation. Specifically, in this embodiment of the present application, gradient back propagation may be optimized through an AdamW optimizer.

In addition, in this embodiment of the present application, other hyper-parameters may include a basic learning rate 1e-3, a weight attenuation 0.1, a learning rate adjustment policy, that is, cosine attenuation, a batch size of 512, and a quantity of training rounds of 30.

### Schematic Estimation Method

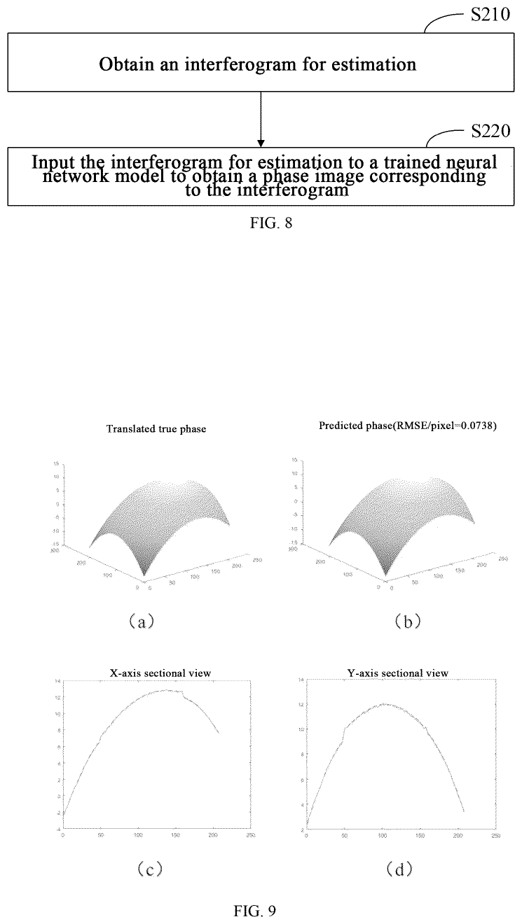

FIG. 8 is a flowchart of an interferogram phase estimation method according to an embodiment of the present application.

As shown in FIG. 8, the interferogram phase estimation method according to this embodiment of the present application includes: step S210 of obtaining an interferogram for estimation; and step S220 of inputting the interferogram for estimation to a trained neural network model to obtain a phase image of an optical fiber end face.

Here, a person skilled in the art can understand that specific details in the interferogram phase estimation method according to this embodiment of the present application are completely the same as corresponding details in the foregoing method for training a neural network model for interferogram phase estimation according to the embodiments of the present application. Details are not described herein again.

Then, after a phase image of a predetermined object, for example, the optical fiber end face, is obtained, another parameter such as a radius of curvature, a vertex offset and an optical fiber height of the predetermined object may be further calculated.

Therefore, in the interferogram phase estimation method according to this embodiment of the present application, the method further includes: calculating, based on the phase image, at least one of the radius of curvature, the vertex offset, and the optical fiber height of the predetermined object.

### Effect Verification

During effect verification, 121000 pairs of optical fiber end face interferograms and phase images in total are first obtained, where 120000 pairs are used as a training set, and the other 100 pairs are used as a test set. Network training and testing may be implemented, for example, on a GPU of a single NVIDIA Quardro RTX 5000 based on a Python-based TensorFlow framework.

In addition, in a training process, an optimizer may be, for example, Adam, and a batch size may be set to, for example, 16. Based on tests, it is determined that an initial learning rate is 1×10−4. A training criterion is that when loss function values of the training set and the test set no longer continuously decrease and get stable (the loss function values no longer decrease after 10 training cycles), the initial learning rate decreases to 1/10 of the original one, and after the initial learning rate changes twice and the loss function values no longer continuously decrease and get stable, training is stopped.

As described above, for the neural network model according to the embodiments of the present application, different quantities of convolutional layer branches, different initial quantities of convolution kernels, and different sizes of the convolution kernel may be set. The following table shows test data of neural network models of different network architectures, where (a, b) represents (initial quantity of convolution kernels of the network, size of the convolution kernel).

TABLE 1
Comparison between optical fiber end face phase estimation effects
of U-net++ of different network architectures

| | | |
|---|---|---|
| | Phase average | |
| Network architecture | RMSE/RRMSE | Test time (s) |

| | | | |
|---|---|---|---|
| Four | (16, 3) | 0.0089/2.0941% | 1.1111 |
| down-sampling | (16, 5) | 0.0059/1.3882% | 1.1557 |
| courses of | (32, 3) | 0.0084/1.9765% | 1.1604 |
| Unet++ | (32, 5) | 0.0053/1.2471% | 1.1792 |
| Five | (16, 3) | 0.0067/1.5765% | 1.5403 |
| up-sampling | (16, 5) | 0.0067/1.5765% | 1.6127 |
| courses of | (32, 3) | 0.0061/1.4353% | 1.6524 |
| Unet++ | (32, 5) | 0.0067/1.5765% | 1.7736 |

It can be learned that the network architecture has best performance when the quantity of convolutional layer branches is 4, the initial quantity of convolution kernels is doubled from 32, and the size of the convolution kernel is 5×5. FIG. 9 is a schematic diagram of a predicted phase result of a preferred neural network model architecture. In FIG. 9, (a) shows a translated true phase, (b) shows a predicted phase of the neural network model, (c) shows an x-axis sectional comparison diagram of (a) and (b) (two solid lines represent the true phase and the predicted phase respectively), and (d) shows a y-axis sectional comparison diagram of (a) and (b) (two solid lines represent the true phase and the predicted phase respectively). As shown in (a) to (d) in FIG. 9, a retrieved phase of the network is very close to the translated true phase, and for the predicted phase, RMSE=0.0738 (RRMSE=0.9597%). In addition, it can be learned from the two lateral views that the network also predicts shape roughness to some extent.

After the phase image is obtained, the radius of curvature, the vertex offset and the optical fiber height may be further calculated based on the predicted phase. The following Table 2 shows test results of some true optical fiber interferograms.

TABLE 2
Parameter estimation results of true optical fiber
end face interferogram obtained by Unet++

| | Image | Radius of | Vertex offset | Optical fiber |
|---|---|---|---|---|
| | number | curvature (mm) | (μm) | height (nm) |
| Value | 1 | 14.01 | 30.64 | −21.68 |
| measured by | 2 | 14.31 | 13.34 | −17.84 |
| Mars-ML400 | 3 | 17.48 | 64.62 | 30.58 |
| | 4 | 10.90 | 15.50 | −20.63 |
| | 5 | 10.62 | 29.55 | 28.97 |
| Predicted | 1 | 13.97 | 30.51 | −22.36 |
| value | 2 | 14.33 | 13.58 | −15.93 |
| | 3 | 17.43 | 65.15 | 26.48 |
| | 4 | 10.91 | 15.41 | −21.81 |
| | 5 | 10.64 | 29.55 | 32.38 |
| Absolute error | 1 | 0.04 | 0.13 | 0.68 |
| | 2 | 0.02 | 0.24 | 1.91 |
| | 3 | 0.05 | 0.53 | 4.10 |
| | 4 | 0.01 | 0.09 | 1.18 |
| | 5 | 0.02 | 0 | 3.41 |

Test absolute errors of 100 true test sets are averaged to statistically obtain absolute errors of the radius of curvature, the vertex offset, and the optical fiber height respectively: ±0.04 mm, ±0.31 μm, and ±2.13 nm.

It can be learned that effect verification shows that the results have reached a commercial grade. Then, accuracy may be further improved, and surface roughness may be described more accurately, to lay a foundation for development and research of a single-interferogram-based carrier-free optical fiber end face interferometer.

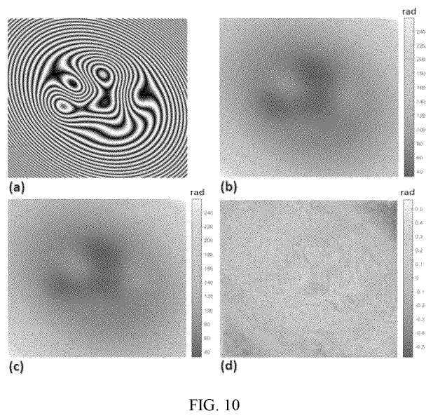

FIG. 10 shows a more general example of simulated interferogram phase estimation. (a) in FIG. 10 shows a simulated interferogram. (b) in FIG. 10 shows a true phase image. (c) in FIG. 10 shows an estimated phase image according to this embodiment of the present application. (d) in FIG. 10 shows an error between the true phase image and the estimated phase image.

FIG. 11 shows a more general example of actual interferogram phase estimation. (a) in FIG. 11 shows an actual interferogram. (b) in FIG. 11 shows a true phase image. (c) in FIG. 11 shows an estimated phase image according to this embodiment of the present application. (d) in FIG. 11 shows an error between the true phase image and the estimated phase image.

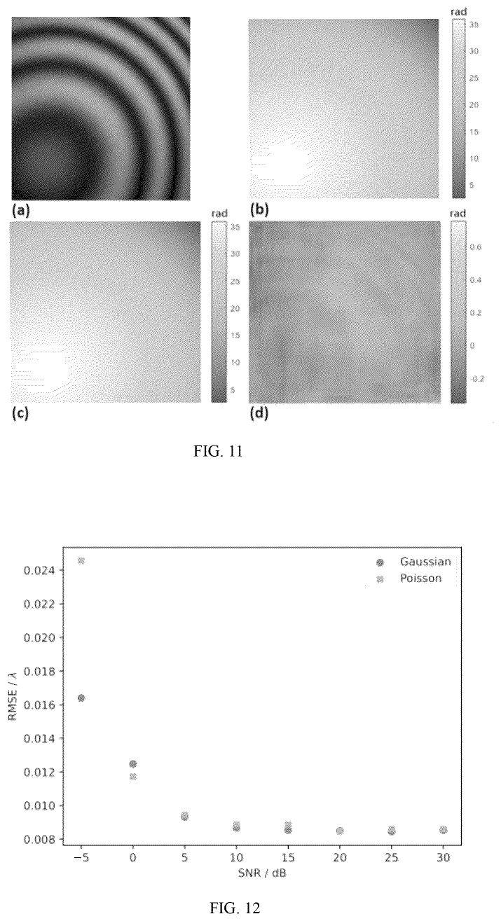

FIG. 12 is a schematic diagram of an error caused by noise in the interferogram phase estimation method according to an embodiment of the present application. It can be learned from FIG. 12 that the interferogram phase estimation method according to the embodiments of the present application is robust to Gaussian noise and Poisson noise.

The basic principle of the present application is described above with reference to specific embodiments. However, it should to be noted that the advantages, superiorities, effects, and the like mentioned in the present application are only exemplary rather than restrictive, and these advantages, superiorities, effects, and the like may be regarded as optional for each embodiment of the present application. In addition, the specific details disclosed above are only for illustration and ease of understanding rather than restrictive, and the details do not limit implementation of the present application.

The block diagrams of the device, apparatus, equipment, and system involved in the present application are only examples and not intended to require or imply connection, arrangement, and configuration to be performed necessarily in manners shown in the block diagrams. As realized by a person skilled in the art, the device, apparatus, equipment, and system may be connected, arranged, and configured in any manner. Terms such as “include”, “contain”, and “have” are open terms, and refer to and are interchangeable with “include, but not limited to”. Terms “or” and “and” used herein refer to and are interchangeable with “and/or”, unless otherwise indicated explicitly in the context. Term “such as” used herein refers to and is interchangeable with “such as, but not limited to”.

It should also to be noted that each component or each step in the apparatus, equipment, and method of the present application may be decomposed and/or recombined. The decomposition and/or recombination should be considered as an equivalent solution of the present application.

The above descriptions about the disclosed aspects are provided such that a person skilled in the art may implement or use the present application. Various modifications about these aspects are apparent to a person skilled in the art, and general principles defined herein may be applied to other aspects without departing from the scope of the present application. Therefore, the present application is not limited to the aspects shown herein but intended to cover the largest scope consistent with the principles and novel features disclosed herein.

The above descriptions have been provided for purposes of illustration and description. In addition, the descriptions are not intended to limit the embodiments of the present application to the forms disclosed herein. Although multiple exemplary aspects and embodiments have been discussed above, a person skilled in the art will learn some transformations, modifications, variations, additions, and sub-combinations thereof.

1-12. (canceled)

13. An interferogram phase estimation method, comprising:
obtaining an interferogram for estimation of a measured object; and
inputting the interferogram for estimation to a neural network model trained based on a method for training a neural network model for interferogram phase estimation, to obtain a phase image corresponding to the interferogram for estimation;
wherein the method for training a neural network model for interferogram phase estimation including:
obtaining a training interferogram and a true phase image of the training interferogram;
inputting the training interferogram to a neural network model, wherein the neural network model has N convolutional layer branches, an i^{th} convolutional layer branch in the N convolutional layer branches has a plurality of N+1−i convolutional layer branches that are cascaded, 1≤i≤N, an output feature map of a first convolutional layer in the i^{th} convolutional layer branch is down-sampled and then input to a first convolutional layer in an (i+1)^{th} convolutional layer branch, an output feature map of a j^{th} convolutional layer in the (i+1)^{th} convolutional layer branch is up-sampled and then input to a (j+1)^{th} convolutional layer in the i^{th} convolutional layer branch, 1≤j≤N+1−i, and an output feature map of each convolutional layer in the i^{th} convolutional layer branch is input to each downstream convolutional layer of the convolutional layer;
obtaining a predicted phase image output by the neural network model;
calculating a loss function value between the predicted phase image and the true phase image; and
training, by minimizing the loss function value, the neural network model through gradient back propagation.

14. The interferogram phase estimation method according to claim 13, wherein the measured object is an interferogram of the optical fiber end face.

15. The interferogram phase estimation method according to claim 14, wherein obtaining an interferogram for estimation of a measured object includes imaging the optical fiber end face through a predetermined image acquisition device to obtain the interferogram of the optical fiber end face.

16. The interferogram phase estimation method according to claim 14, wherein obtaining an interferogram for estimation of a measured object includes:
providing an optical fiber connector to be determined qualified; and
imaging the optical fiber end face of the optical fiber connector through a predetermined image acquisition device to obtain the interferogram of the optical fiber end face.

17. The interferogram phase estimation method according to claim 13, wherein obtaining a training interferogram includes:
imaging a predetermined object through a predetermined image acquisition device to obtain the training interferogram.

18. The interferogram phase estimation method according to claim 17, wherein imaging a predetermined object through a predetermined image acquisition device to obtain the training interferogram includes:
imaging the predetermined object through the predetermined image acquisition device based on a multi-step phase shifting method, to obtain a plurality of interferograms with a plurality of phases; and
obtaining a phase-shift-free interferogram as the training interferogram.

19. The interferogram phase estimation method according to claim 13, wherein a quantity of convolutional layer branches of the neural network model is 4, a quantity of convolution kernels is doubled from 32, and a size of a convolution kernel is 5×5.

20. The interferogram phase estimation method according to claim 13, wherein each convolution layer comprises a ResBlock convolution block.

21. The interferogram phase estimation method according to claim 13, wherein before the inputting the training interferogram to a neural network model, the method further comprises:
performing image cropping or image augmentation on the training interferogram.

22. The interferogram phase estimation method according to claim 21, wherein the performing image cropping or image augmentation on the training interferogram comprises:
when a quantity of convolution layer branches is less than or equal to a predetermined threshold, performing image cropping on the training interferogram; or
when a quantity of convolution layer branches is greater than a predetermined threshold, performing image augmentation on the training interferogram.

23. The interferogram phase estimation method according to claim 21, wherein the performing image cropping or image augmentation on the training interferogram comprises:
when image cropping is performed on the training interferogram, a quantity of pixels in a cropped image is sufficient to fit an ideal sphere.

24. The interferogram phase estimation method according to claim 13, rein the loss function value is a root mean square error loss function value, and is represented as:
$${ℒ}_{RMSE} = \sqrt{\frac{1}{k} {\sum }_{i = 1}^{k} {( {F}_{1}^{( i )} - {F}_{2}^{( i )} )}^{2}}$$
where F₁⁽ⁱ⁾ and F₂⁽ⁱ⁾ are respectively matrix representations of a predicted phase image and a true phase image that correspond to an i^{th} interferogram in k interferograms in total, and matrix sizes of the predicted phase image and the true phase image are m×n.

25. The interferogram phase estimation method according to claim 13, wherein the loss function value is a relative root mean square error loss function value, and is represented as:
$${ℒ}_{RRMSE} = \frac{1}{k} {\sum }_{i = 1}^{k} \frac{\sqrt{{\sum }_{a = 1}^{m} {\sum }_{b = 1}^{n} {( {F}_{{1}_{a , b}}^{( i )} - {F}_{{2}_{a , b}}^{( i )} )}^{2}}}{{max}_{a , b} ( {F}_{{2}_{a , b}}^{( i )} ) - {min}_{a , b} ( {F}_{{2}_{a , b}}^{( i )} )}$$
where F₁⁽ⁱ⁾_{a,b} and F₂⁽ⁱ⁾_{a,b} are respectively pixel values at a location (a, b) in a predicted phase image and a true phase image that correspond to an i^{th} interferogram in k interferograms in total.

26. The interferogram phase estimation method according to claim 13, further comprising:
calculating, based on the phase image, at least one of a radius of curvature, a vertex offset, and an optical fiber height of a predetermined object.
